(19) United States
(12) Patent Application Publication
(10) Pub. No.: US 2008/0076884 A1
(43) Pub. Date: Mar. 27, 2008

(54) POLY(ARYLENE ETHER) COMPOSITION AND METHOD

(76) Inventors: Gary William Yeager, Rexford, NY (US); Joshua Stone, Worcester, NY (US)

Correspondence Address: CANTOR COLBURN LLP - SABIC (NORYL), 20 Church Street, 22nd Floor, Hartford, CT, 06103, US

(21) Appl. No.: 11/533,969

(22) Filed: Sep. 21, 2006

(51) Int. Cl. C08L 71/12; C08L 71/10; C08G 65/38

(52) U.S. Cl. 525/534; 524/611

(57) ABSTRACT

A composition containing a solvent and a soluble poly(arylene ether) copolymer is described. The poly(arylene ether) copolymer is the product of oxidative polymerization of monomers including a first monohydric phenol having identical substituents in the 2- and 6-positions, and a second monohydric phenol having different substituents in the 2- and 6-positions. The monomers are free of ethylenic unsaturation. The solvent may be a ketone, a dialkylamide, a dialkyl ether, an aromatic hydrocarbon, a chlorinated hydrocarbon, an alkyl alkanoate, an alkyl cyanide, a dialkyl sulfoxide, or a mixture thereof. The poly(arylene ether) has a solubility in the composition of at least 10 grams per kilogram of composition at 25° C.

### BACKGROUND OF THE INVENTION

Thermoset resins are materials that cure to form very hard plastics. These materials that can be used in a wide variety of consumer and industrial products. For example, thermosets are used in protective coatings, adhesives, electronic laminates (such as those used in the fabrication of computer circuit boards), flooring and paving applications, glass fiber-reinforced pipes, and automotive parts (including leaf springs, pumps, and electrical components). Relative to other types of plastics, cured thermosets are typically brittle. It would therefore be desirable to retain the good properties of thermosets and also reduce their brittleness.

Poly(arylene ether) resins, sometimes called polyphenylene ethers, have been disclosed as additives to reduce the brittleness (improve the toughness) of cured thermosets. For example, it is known to combine certain poly(arylene ether) resins with thermosets resins such as epoxies, cyanate esters, maleimides, acrylates, and benzoxazine resins. These poly(arylene ether)-containing compositions are often processed in solvents to reduce the viscosity of the curable composition and to enhance impregnation of the curable composition into fillers and/or reinforcements. When a solvent is used, it would be preferable to use a non-chlorinated hydrocarbon solvent. However, non-chlorinated hydrocarbon solvents such as N-methyl-2-pyrrolidone (NMP), toluene, and xylene are not ideal for this purpose because they produce phase-separated mixtures with poly(2,6-dimethyl-1,4-phenylene ether) at room temperature. Improvements in the miscibility of poly(arylene ether)s and solvents have been obtained by processing curable compositions containing them at elevated temperatures as described, for example, in Japanese Patent Application Publication No. JP 06-220226 A of Katayose et al. However, it would be desirable to avoid the use of elevated temperatures because they are associated with increased solvent flammability, increased solvent emissions, and increased energy costs. Another method of improving the miscibility of poly(arylene ether)s and solvents has been to reduce the molecular weight of the poly(arylene ether). However, reducing the poly(arylene ether) molecular weight reduces the heat resistance and toughness of the ultimate cured composition. There is therefore a need to develop materials and methods providing homogeneous poly(arylene ether) solutions in non-halogenated solvents such as NMP, toluene, and xylene at room temperature.

### BRIEF DESCRIPTION OF THE INVENTION

One embodiment is a composition, comprising: a poly(arylene ether) that is the product of oxidative polymerization of monomers comprising a first monohydric phenol having identical substituents in the 2- and 6-positions, and a second monohydric phenol having different substituents in the 2- and 6-positions; wherein the monomers are free of ethylenic unsaturation; and a solvent selected from the group consisting of C₃-C₈ ketones, C₄-C₈ N,N-dialkylamides, C₄-C₁₆ dialkyl ethers, C₆-C₁₂ aromatic hydrocarbons, C₁-C₃ chlorinated hydrocarbons, C₃-C₆ alkyl alkanoates, C₂-C₆ allyl cyanides, C₂-C₆ dialkyl sulfoxides, and mixtures thereof; wherein the poly(arylene ether) has a solubility in the composition of at least 10 grams per kilogram of composition at 25° C.

One embodiment is a composition, comprising: a poly(arylene ether) that is the product of oxidative polymerization of monomers comprising a first monohydric phenol having identical substituents in the 2- and 6-positions, and a second monohydric phenol having different substituents in the 2- and 6-positions; wherein the monomers are free of ethylenic unsaturation; and a solvent comprising a C₃-C₈ ketone; wherein the poly(arylene ether) has a solubility in acetone of at least 10 grams per kilogram at 25° C., based on the total weight of poly(arylene ether) and acetone.

One embodiment is a composition, comprising: a poly(arylene ether) that is the product of oxidative polymerization of monomers comprising a first monohydric phenol having identical substituents in the 2- and 6-positions, and a second monohydric phenol having different substituents in the 2- and 6-positions; wherein the monomers are free of ethylenic unsaturation; and a solvent comprising a C₄-C₈ N,N-dialkylamide; wherein the poly(arylene ether) has a solubility in N,N-dimethylformamide of at least 10 grams per kilogram at 25° C., based on the total weight of poly(arylene ether) and N,N-dimethylformamide.

One embodiment is a composition, comprising: a poly(arylene ether) that is the product of oxidative polymerization of monomers comprising a first monohydric phenol having identical substituents in the 2- and 6-positions, and a second monohydric phenol having different substituents in the 2- and 6-positions; wherein the monomers are free of ethylenic unsaturation; and a solvent comprising a C₄-C₁₆ dialkyl ether; wherein the poly(arylene ether) has a solubility in ethylene glycol monomethyl ether of at least 10 grams per kilogram at 25° C., based on the total weight of poly(arylene ether) and ethylene glycol monomethyl ether.

One embodiment is a composition, comprising: a poly(arylene ether) that is the product of oxidative polymerization of monomers comprising a first monohydric phenol having identical substituents in the 2- and 6-positions, and a second monohydric phenol having different substituents in the 2- and 6-positions; wherein the monomers are free of ethylenic unsaturation; and a solvent comprising a C₆-C₁₂ aromatic hydrocarbon; wherein the poly(arylene ether) has a solubility in toluene of at least 10 grams per kilogram at 25° C., based on the total weight of poly(arylene ether) and toluene.

One embodiment is a composition, comprising: a poly(arylene ether) that is the product of oxidative polymerization of monomers comprising a first monohydric phenol having identical substituents in the 2- and 6-positions, and a second monohydric phenol having different substituents in the 2- and 6-positions; wherein the monomers are free of ethylenic unsaturation; and a solvent comprising a C₁-C₃ chlorinated hydrocarbon; wherein the poly(arylene ether) has a solubility in trichloroethylene of at least 10 grams per kilogram at 25° C., based on the total weight of poly(arylene ether) and trichloroethylene.

One embodiment is a composition, comprising: a poly(arylene ether) that is the product of oxidative polymerization of monomers comprising a first monohydric phenol having identical substituents in the 2- and 6-positions, and a second monohydric phenol having different substituents in the 2- and 6-positions; wherein the monomers are free of ethylenic unsaturation; and a solvent comprising a C₃-C₆ alkyl alkanoate; wherein the poly(arylene ether) has a solubility in ethyl acetate of at least 10 grams per kilogram at 25° C., based on the total weight of poly(arylene ether) and ethyl acetate.

One embodiment is a composition, comprising: a poly(arylene ether) that is the product of oxidative polymerization of monomers comprising a first monohydric phenol having identical substituents in the 2- and 6-positions, and a second monohydric phenol having different substituents in the 2- and 6-positions; wherein the monomers are free of ethylenic unsaturation; and a solvent comprising a C₂-C₆ allyl cyanide; wherein the poly(arylene ether) has a solubility in acetonitrile of at least 10 grams per kilogram at 25° C., based on the total weight of poly(arylene ether) and acetonitrile.

One embodiment is a composition, consisting of: a poly(arylene ether) that is the product of oxidative polymerization of monomers comprising a first monohydric phenol having identical substituents in the 2- and 6-positions, and a second monohydric phenol having different substituents in the 2- and 6-positions; wherein the monomers are free of ethylenic unsaturation; and a solvent selected from the group consisting of C₃-C₈ ketones, C₄-C₈ N,N-dialkylamides, C₄-C₁₆ dialkyl ethers, C₆-C₁₂ aromatic hydrocarbons, and mixtures thereof; wherein the poly(arylene ether) has a solubility in the composition of about 10 to about 700 grams per kilogram of composition at 25° C.

One embodiment is a composition, comprising: a poly(arylene ether) that is the product of oxidative polymerization of monomers comprising about 30 to about 90 weight percent of a first monohydric phenol comprising 2,6-dimethylphenol, and about 10 to about 70 weight percent of a second monohydric phenol selected from the group consisting of 2-methylphenol, 2-methyl-6-phenylphenol, and mixtures thereof; wherein the weight percents of the first monohydric phenol and the second monohydric phenol are based on the total weight of monomers; wherein the monomers are free of ethylenic unsaturation; and wherein the poly(arylene ether) has an intrinsic viscosity of about 0.05 to about 0.6 deciliter per gram, measured at 25° C. in chloroform; and a solvent selected from the group consisting of acetone, methyl ethyl ketone, N-methyl-2-pyrrolidone, toluene, and mixtures thereof; wherein the poly(arylene ether) has a solubility in the composition of about 100 to about 700 grams per kilogram of composition at 25° C.; and wherein the poly(arylene ether) is soluble in the composition at 25° C.

One embodiment is a composition, consisting of: a poly(arylene ether) that is the product of oxidative polymerization of monomers comprising about 30 to about 90 weight percent of a first monohydric phenol comprising 2,6-dimethylphenol, about 10 to about 70 weight percent of a second monohydric phenol selected from the group consisting of 2-methylphenol, 2-methyl-6-phenylphenol, and mixtures thereof, and optionally, a dihydric phenol selected from the group consisting of 2,2-bis(4-hydroxyphenyl)propane, 2,2-bis(4-hydroxy-2,6-dimethylphenyl)propane, 4,4-bis(3,5-dimethyl-4-hydroxyphenyl)pentanoic acid, 4,4-bis(4-hydroxyphenyl)pentanoic acid, 2,2′6,6′-tetramethyl-3,3′5,5′-tetrabromo-4,4′-biphenol, 2,2′5,5′-tetramethyl-4,4′-biphenol, and mixtures thereof; wherein the weight percents of the first monohydric phenol and the second monohydric phenol are based on the total weight of monomers; wherein the monomers are free of ethylenic unsaturation; and wherein the poly(arylene ether) has an intrinsic viscosity of about 0.05 to about 0.6 deciliters per gram, measured at 25° C. in chloroform; and a solvent selected from the group consisting of acetone, methyl ethyl ketone, N-methyl-2-pyrrolidone, toluene, and mixtures thereof; wherein the poly(arylene ether) has a solubility in the composition of about 100 to about 700 grams per kilogram of composition at 25° C.; and wherein the poly(arylene ether) is soluble in the composition at 25° C.

One embodiment is a composition, comprising: about 20 to about 50 weight percent of a poly(arylene ether) that is the product of oxidative polymerization of monomers comprising about 30 to about 90 weight percent of a first monohydric phenol comprising 2,6-dimethylphenol, and about 10 to about 70 weight percent of a second monohydric phenol selected from the group consisting of 2-methylphenol, 2-methyl-6-phenylphenol, and mixtures thereof; wherein the monomers are free of ethylenic unsaturation; wherein the poly(arylene ether) has an intrinsic viscosity of about 0.1 to about 0.6 deciliter per gram, measured at 25° C. in chloroform; and wherein the weight percents of the first monohydric phenol and the second monohydric phenol are based on the total weight of monomers; about 20 to about 80 weight percent of a solvent selected from the group consisting of acetone, methyl ethyl ketone, N-methyl-2-pyrrolidone, toluene, and mixtures thereof; wherein the weight percents of the poly(arylene ether) and the solvent are based on the total weight of the composition; wherein the poly(arylene ether) has a solubility in the composition of about 100 to about 700 grams per kilogram of composition at 25° C.; and wherein the poly(arylene ether) is soluble in the composition at 25° C.

One embodiment is a composition, consisting of: about 20 to about 50 weight percent of a poly(arylene ether) that is the product of oxidative polymerization of monomers comprising about 30 to about 90 weight percent of a first monohydric phenol comprising 2,6-dimethylphenol, about 10 to about 70 weight percent of a second monohydric phenol selected from the group consisting of 2-methylphenol, 2-methyl-6-phenylphenol, and mixtures thereof, and optionally, about 2 to about 20 weight percent of a dihydric phenol selected from the group consisting of 2,2-bis(4-hydroxyphenyl)propane, 2,2-bis(4-hydroxy-2,6-dimethylphenyl)propane, 4,4-bis(3,5-dimethyl-4-hydroxyphenyl)pentanoic acid, 4,4-bis(4-hydroxyphenyl)pentanoic acid, 2,2′6,6′-tetramethyl-3,3′5,5′-tetrabromo-4,4′-biphenol, 2,2′5,5′-tetramethyl-4,4′-biphenol, and mixtures thereof; wherein the monomers are free of ethylenic unsaturation; wherein the poly(arylene ether) has an intrinsic viscosity of about 0.1 to about 0.6 deciliter per gram, measured at 25° C. in chloroform; and wherein the weight percents of the first monohydric phenol and the second monohydric phenol are based on the total weight of monomers; about 20 to about 80 weight percent of a solvent selected from the group consisting of acetone, methyl ethyl ketone, N-methyl-2-pyrrolidone, toluene, and mixtures thereof; wherein the weight percents of the poly(arylene ether) and the solvent are based on the total weight of the composition; wherein the poly(arylene ether) has a solubility in the composition of about 100 to about 700 grams per kilogram of composition at 25° C.; and wherein the poly(arylene ether) is soluble in the composition at 25° C.

One embodiment is a composition, comprising: adjusting the temperature of a solvent to a temperature in a range from about 30° C. to the atmospheric boiling point of the solvent; wherein the solvent is selected from the group consisting of C₃-C₈ ketones, C₄-C₈ N,N-dialkylamides, C₄-C₁₆ diallyl ethers, C₆-C₁₂ aromatic hydrocarbons, and mixtures thereof, combining the temperature-adjusted solvent with a poly(arylene ether) that is the product of oxidative polymerization of monomers comprising a first monohydric phenol having identical substituents in the 2- and 6-positions, and a second monohydric phenol having different substituents in the 2- and 6-positions; wherein the monomers are free of ethylenic unsaturation; and agitating the combined solvent and poly(arylene ether) to form the poly(arylene ether) composition; wherein the poly(arylene ether) has a solubility in the composition of at least 10 grams per kilogram of composition at 25° C.

Other embodiments are described in detail below.

### DETAILED DESCRIPTION OF THE INVENTION

In the course of research on poly(arylene ether) copolymers and their solubility properties, the present inventors have discovered that particular poly(arylene ether) copolymers exhibit markedly improved solubility in non-halogenated solvents compared to poly(2,6-dimethyl-1,4-phenylene ether)s of comparable molecular weight. In particular, these particular copolymers enable the preparation of concentrated solutions at room temperature in non-halogenated solvents. These solutions eliminate the need to handle solutions at elevated temperature. These solutions also eliminate the need to reduce the molecular weight of the poly(arylene ether)—and thereby sacrifice physical and thermal properties—in order to improve solubility.

The poly(arylene ether) exhibiting improved solubility may comprise ethylenic unsaturation, or it may be free of ethylenic unsaturation. Both types of poly(arylene ether) compositions are useful in the preparation of thermoset compositions. In the embodiment in which the poly(arylene ether) is free of ethylenic unsaturation, the composition comprises a poly(arylene ether) that is the product of oxidative polymerization of monomers comprising a first monohydric phenol having identical substituents in the 2- and 6-positions, and a second monohydric phenol having different substituents in the 2- and 6-positions; wherein the monomers are free of ethylenic unsaturation; and a solvent selected from the group consisting of C₃-C₈ ketones, C₄-C₈ N,N-dialkylamides, C₄-C₁₆ dialkyl ethers, C₆-C₁₂ aromatic hydrocarbons, C₃-C₆ chlorinated hydrocarbons, C₃-C₆ alkyl alkanoates, C₂-C₆ alkyl cyanides, C₂-C₆ dialkyl sulfoxides, and mixtures thereof; wherein the poly(arylene ether) has a solubility in the composition of at least 10 grams per kilogram of composition at 25° C. In the embodiments in which the poly(arylene ether) comprises ethylenic unsaturation, the composition comprises a poly(arylene ether) that is the product of oxidative polymerization of monomers comprising a first monohydric phenol having identical substituents in the 2- and 6-positions, and a second monohydric phenol comprising ethylenic unsaturation and having different substituents in the 2- and 6-positions; and a solvent selected from the group consisting of C₃-C₈ ketones, C₄-C₈ N,N-dialkylamides, C₄-C₁₆ dialkyl ethers, C₆-C₁₂ aromatic hydrocarbons, C₃-C₆ chlorinated hydrocarbons, C₃-C₆ alkyl alkanoates, C₂-C₆ alkyl cyanides, C₂-C₆ dialkyl sulfoxides, and mixtures thereof; wherein the poly(arylene ether) has a solubility in the composition of at least 10 grams per kilogram of composition at 25° C. In some embodiments, the solvent is an aromatic hydrocarbon comprising ethylenic unsaturation, such as, for example, styrene.

The solubility of the poly(arylene ether) in the composition is at least 10 grams per kilogram of composition at 25° C. In some embodiments, the solubility is at least 20 grams per kilogram, or at least 50 grams per kilogram, or at least 100 grams per kilogram, or at least 200 grams per kilogram, all at 25° C. In some embodiments, the solubility is less than or equal to 700 grams per kilogram, or less than or equal to 500 grams per kilogram, or less than or equal to 300 grams per kilogram, all at 25° C. The solubility of the poly(arylene ether) is determined according to a modified version of ASTM D3132-84, Standard Test Method of Solubility Range of Resins and Polymers (Reapproved 1996; Withdrawn 2005). Rather than testing solubility of a polymer resin in a variety of solvent compositions, as in ASTM D3132-84, solubility in a single solvent composition may be determined. For example, to determine whether the solubility of the poly(arylene ether) in the composition is at least 10 grams per kilogram of composition at 25° C., the following procedure may be used. Poly(arylene ether) (0.05 gram) is combined with solvent (4.95 grams) in a 15 milliliter cylindrical clear glass vial at 25° C. The vial is then closed with a screw cap and tumbled or rotated end-over-end at about one to five revolutions per minute for 24 hours at 25° C. At the end of 24 hours, the contents of the vial are visually inspected and classified as a complete solution (a single, clear liquid phase with no distinct solid or gel particles), a borderline solution (cloudy or turbid but without distinct phase separation), or insoluble (two phases; either a liquid with separate gel or solid phase or two separate liquids). If the contents of the vial are classified as a complete solution, then the poly(arylene ether) has a solubility of at least 10 grams per kilogram at 25° C.

In some embodiments, most or all of the poly(arylene ether) is dissolved in the composition at room temperature. Thus, in some embodiments, at least 90 weight percent, or at least 95 weight percent, or at least 98 weight percent, or at least 99 weight percent, of the poly(arylene ether) is soluble in the composition at 25° C. The weight percent of poly(arylene ether) dissolved in the composition at room temperature may be determined using a modified version of ASTM D1766-05, Standard Test Method for Rubber Chemicals—Solubility. For example, rather than intentionally adding excess solid polymer, as in ASTM D1766-05, poly(arylene ether) may be used at a specified concentration, such as 10 grams per kilogram at 25° C. Thus, 0.5 grams of poly(arylene ether) may be combined with 49.5 grams of solvent at 25° C. in a 100 milliliter glass screw-cap vial. The vial is then placed in a mechanical shaker for a minimum of four hours. The vial is then held at 25° C. with occasional shaking for an additional four hours. Then, any visible solids are allowed to settle. (An optional centrifuging step may be added to separate suspended solid.) A 25-milliliter portion of the solution is removed by pipetting and transferred to a tared, ground glass, low-form, 50 milliliter covered weighing bottle. The mass of the bottle plus solution is determined. The solvent is then evaporated at a temperature less than or equal to 110° C. until a constant mass is obtained. The mass of the weighing bottle plus residue is determined. If the initial bottle tare mass is A, and the mass of bottle plus solution is B, and the mass of the bottle plus residue is C, then the solubility of the poly(arylene ether) in grams per kilogram of composition is

=[(C−A)/(B−C)]×1000

and the percent solubility is 100 times the actual solubility in grams per kilogram of composition divided by the theoretical solubility of 10 grams per kilogram.

The poly(arylene ether) is the product of oxidative polymerization of monomers comprising a first monohydric phenol and a second monohydric phenol. The first monohydric phenol has identical substituents in the 2- and 6-positions of the phenol ring, where ring substituents are as numbered as shown below with the phenolic hydroxy group in the 1-position.

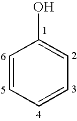

In some embodiments, the first monohydric phenol has the formula

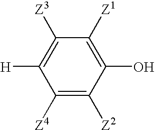

wherein Z¹ and Z² are the same and may be halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; and Z³ and Z⁴ are the same or different and each independently may be hydrogen, halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms. As used herein, the term “hydrocarbyl”, whether used by itself, or as a prefix, suffix, or fragment of another term, refers to a residue that contains only carbon and hydrogen. The residue may be aliphatic or aromatic, straight-chain, cyclic, bicyclic, branched, saturated, or unsaturated. It may also contain combinations of aliphatic, aromatic, straight chain, cyclic, bicyclic, branched, saturated, and unsaturated hydrocarbon moieties. However, when the hydrocarbyl residue is described as “substituted”, may contain heteroatoms over and above the carbon and hydrogen members of the substituent residue. Thus, when specifically described as substituted, the hydrocarbyl residue may also contain halogen atoms, nitro groups, cyano groups, carbonyl groups, carboxylic acid groups, amino groups, amide groups, sulfonyl groups, sulfoxyl groups, sulfonamide groups, hydroxyl groups, alkoxyl groups, or the like, or it may contain heteroatoms within the backbone of the hydrocarbyl residue.

In some embodiments, the first monohydric phenol is selected from the group consisting of 2,6-dimethylphenol, 2,6-diphenylphenol, and mixtures thereof. In some embodiments, the first monohydric phenol is 2,6-dimethylphenol.

The second monohydric phenol has different substituents in the 2- and 6-positions. In some embodiments, the second monohydric phenol is free of ethylenic unsaturation and has the formula

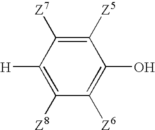

wherein each Z⁵, Z⁶, Z⁷, and Z⁸ is independently hydrogen, halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₁-C₁₂ halohydrocarbyloxy wherein at least two carbon atoms separate the halogen and oxygen atoms, with the proviso that Z⁵ and Z⁶ are different, and with the proviso that Z⁵, Z⁶, Z⁷, and Z⁸ are free of ethylenic unsaturation.

In the embodiments in which the second monohydric phenol is free of ethylenic unsaturation, it may be, for example, 2-methylphenol, 2-ethylphenol, 2-(1-methylethyl)phenol, 2(1-methylpropyl)phenol, 2(1-methylbutyl)phenol, 2(1-methylpentyl)phenol, 2-(1-methylheptyl)phenol 2-(1-methylundecyl)phenol, 2-propylphenol, 2-cyclohexylphenol, 2-cyclopentylphenol, 2-cyclopropylphenol, 2-methyl-6-phenylphenol, 2-methyl-6-benzylphenol, 2-(1-phenylethyl)phenol, 2-methyl-6-(1-phenylethyl)phenol, 2-ethyl-6-methylphenol, 2-methyl-6-(1-methylethyl)phenol, 2-methyl-6-(1-methylpropyl)phenol, 2-methyl-6-(1-methylbutyl)phenol, 2-methyl-6-(1-methylpentyl)phenol, 2-methyl-6-(1-methylheptyl)phenol, 2-methyl-6-(1-methylundecyl)phenol, 2-methyl-6-propylphenol, 2-cyclohexyl-6-methylphenol, 2-cyclopentyl-6-methylphenol, 2-cyclopropyl-6-methylphenol, 2-methyl-6-methoxyphenol, 2-methyl-5-isopropylphenol, 2-isopropyl-5-methylphenol, 2,5-dimethylphenol, 3-pentadecylphenol, and mixtures thereof.

In some embodiments, the second monohydric phenol comprises ethylenic unsaturation. As used herein, the term “ethylenic unsaturation” refers collectively to aliphatic carbon-carbon double bonds and aliphatic carbon-carbon triple bonds. In some embodiments, the second monohydric phenol comprises at least one ethylenically unsaturated substituent bound directly to the phenol aromatic ring, wherein the ethylenically unsaturated substituent is

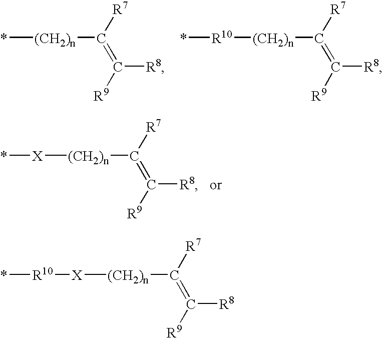

wherein n is 0 or 1, R⁷ and R⁸ and R⁹ are each independently is hydrogen or C₁-C₆ allyl, R¹⁰ is C₁-C₁₂ hydrocarbylene, and X is —C(═O)—, —O—, —N(R¹¹)—, —C(═O)O—, or —C(═O)N(R¹¹)—, wherein R¹¹ is hydrogen, methyl, vinyl, or allyl. When the second monohydric phenol comprises ethylenic unsaturation, it may comprise more than one ethylenically unsaturated substituent.

In some embodiments, the second monohydric phenol comprises, in addition to the at least one ethylenically unsaturated substituent, at least one directly bound substituent such as halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms.

Suitable second monohydric phenols comprising an ethylenically unsaturated substituent include, for example, 2-vinylphenol, 2-allylphenol, 2-methyl-6-vinylphenol, 2-methyl-6-allylphenol, 2-(N,N-diallylaminomethyl)phenol, 2-(N,N-diallylpropionamido)phenol, 2-methyl-6-allyloxyphenol, and mixtures thereof. In some embodiments, the second monohydric phenol is 2-allylphenol, 2-methyl-6-allylphenol, or a mixture thereof.

When the second monohydric phenol comprises ethylenic unsaturation, the monomers may comprise, in addition to the first monohydric phenol and the second monohydric phenol, a third monohydric phenol different from the first monohydric phenol and the second monohydric phenol. The third monohydric differs from the first monohydric phenol in that it has different substituents in the 2- and 6-positions. The third monohydric differs from the second monohydric phenol in that it lacks ethylenic unsaturation. In some embodiments, the third monohydric phenol has the formula

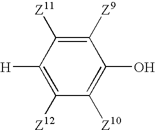

wherein Z⁹, Z¹⁰, Z¹¹, and Z¹² each independently may be hydrogen, halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₁-C₁₂ halohydrocarbyloxy wherein at least two carbon atoms separate the halogen and oxygen atoms, with the proviso that Z⁹ and Z¹⁰ are different. When employed, the third monohydric phenol may be used in an amount of about 1 to about 89 weight percent, based on the total weight of the phenolic monomers. Within this range, the third monohydric phenol amount may be at least about 10 weight percent, or at least about 20 weight percent. Also within this range, the third monohydric phenol amount may be up to about 70 weight percent, or up to about 50 weight percent.

In addition to the monomers discussed above, the monomers may further comprise a dihydric phenol having the formula

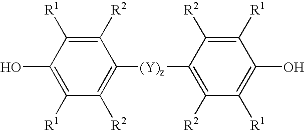

wherein each occurrence of R¹ and R² is independently selected from the group consisting of hydrogen, halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₁-C₁₂ halohydrocarbyloxy wherein at least two carbon atoms separate the halogen and oxygen atoms; z is 0 or 1; and Y has a structure selected from the group consisting of

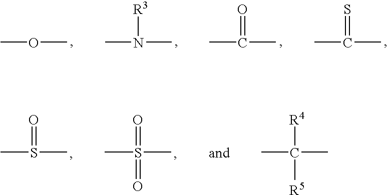

wherein each occurrence of R³ is independently selected from the group consisting of hydrogen and C₁-C₁₂ hydrocarbyl, and each occurrence of R⁴ and R⁵ is independently selected from the group consisting of hydrogen, C₁-C₁₂ hydrocarbyl, and C₁-C₆ hydrocarbylene wherein R⁴ and R⁵ collectively form a C₄-C₁₂ alkylene group.

In some embodiments, the dihydric phenol may be 3,3′,5,5′-tetramethyl-4,4′-biphenol, 2,2-bis(3-methyl-4-hydroxyphenyl)propane, 2,2-bis(3,5-dimethyl-4-hydroxyphenyl)propane, 1,1-bis(4-hydroxyphenyl)methane, 1,1-bis(4-hydroxyphenyl)ethane, 2,2-bis(4-hydroxyphenyl)propane, 2,2-bis(4-hydroxyphenyl)butane, 2,2-bis(4-hydroxyphenyl)octane, 1,1-bis(4-hydroxyphenyl)propane, 1,1-bis(4-hydroxyphenyl)-n-butane, bis(4-hydroxyphenyl)phenylmethane, 2,2-bis(4-hydroxy-3-methylphenyl)propane, 1,1-bis(4-hydroxy-3-methylphenyl)cyclohexane, 1,1-bis(4-hydroxy-3,5-dimethylphenyl)cyclopentane, 1,1-bis(4-hydroxy-3,5-dimethylphenyl)cyclohexane, 1,1-bis(4-hydroxy-3-methylphenyl)cycloheptane, 1,1-bis(4-hydroxy-3,5-dimethylphenyl)cycloheptane, 1,1-bis(4-hydroxy-3-methylphenyl)cyclooctane, 1,1-bis(4-hydroxy-3,5-dimethylphenyl)cyclooctane, 1,1-bis(4-hydroxy-3-methylphenyl)cyclononane, 11,1-bis(4-hydroxy-3,5-dimethylphenyl)cyclononane, 1,1-bis(4-hydroxy-3-methylphenyl)cyclodecane, 1,1-bis(4-hydroxy-3,5-dimethylphenyl)cyclodecane, 1,1-bis(4-hydroxy-3-methylphenyl)cycloundecane, 1,1-bis(4-hydroxy-3,5-dimethylphenyl)cycloundecane, 1,1-bis(4-hydroxy-3-methylphenyl)cyclododecane, 1,1-bis(4-hydroxy-3,5-dimethylphenyl)cyclododecane, 1,1-bis(4-hydroxy-3-t-butylphenyl)propane, 2,2-bis(4-hydroxy-2,6-dimethylphenyl)propane, 2,2-bis(4-hydroxy-3-bromophenyl)propane, 1,1-bis(4-hydroxyphenyl)cyclopentane, 1,1-bis(4-hydroxyphenyl)cyclohexane, or a combination thereof.

When employed, the dihydric phenol may be used in an amount such that the weight ratio of total monohydric phenol to dihydric phenol is about 3 to about 110. Within this range, the weight ratio may be at least about 5, or at least about 7. Also within this range, the ratio may be up to about 50, or up to about 25.

In the embodiments in which the phenolic monomers are free of ethylenic unsaturation, they may comprise about 1 to about 90 weight percent of the first monohydric phenol and about 10 to about 99 weight percent of the second monohydric phenol. The weight percent of the first monohydric phenol may be at least about 5, or at least about 10, or at least about 20, or at least about 30. The weight percent of the first monohydric phenol may be up to about 80, or up to about 70. The weight percent of the second monohydric phenol may be at least about 20, or at least about 30, or at least about 40. The weight percent of the second monohydric phenol may be up to about 95, or up to about 90, or up to about 80, or up to about 70. In this context, all weight percents are based on the total weight of the monomers.

In the embodiments in which the second phenolic monomer comprises ethylenic unsaturation, the phenolic monomers may comprise about 5 to about 95 weight percent of the first monohydric phenol and about 5 to about 95 weight percent of the second monohydric phenol, based on the total weight of phenolic monomers. Within the above range, the first phenolic monomer amount may be at least about 10 weight percent, or at least about 20 weight percent. Also within the above range, the first phenolic monomer amount may be up to about 90 weight percent, or up to about 80 weight percent. Within the above range, the second phenolic monomer amount may be at least about 10 weight percent, or at least about 20 weight percent. Also within the above range, the second phenolic monomer amount may be up to about 90 weight percent, or up to about 80 weight percent.

In the embodiments in which the second phenolic monomer comprises ethylenic unsaturation, the poly(arylene ether) necessarily comprises ethylenic unsaturation. In these embodiments, the composition may, optionally, further comprise a poly(arylene ether) free of ethylenic unsaturation.

The poly(arylene ether) prepared by oxidative copolymerization of the monomers may have an intrinsic viscosity of about 0.05 to about 1.5 deciliters per gram measured in chloroform at 25° C. Within this range, the intrinsic viscosity may be at least about 0.1 deciliter per gram, or at least about 0.15 deciliter per gram, or at least about 0.2 deciliter per gram, or at least about 0.3 deciliter per gram. Also within this range, the intrinsic viscosity may be up to about 1 deciliter per gram, or up to about 0.6 deciliter per gram.

In some embodiments, the poly(arylene ether) has a number average molecular weight of about 10,000 to about 50,000 atomic mass units. In one embodiment, the poly(arylene ether) has a number average molecular weight of about 15,000 to about 40,000 atomic mass units. In one embodiment, the poly(arylene ether) has a number average molecular weight of about 20,000 to about 30,000 atomic mass units. One advantage of the present composition is that it may exhibit lower viscosity than a composition containing a poly(2,6-dimethyl-1,4-phenylene ether) of the same molecular weight and in the same amount.

In addition to the poly(arylene ether), the composition comprises a solvent selected from C₃-C₈ ketones, C₄-C₈ N,N-dialkylamides (including lactams), C₄-C₁₆ dialkyl ethers, C₆-C₁₂ aromatic hydrocarbons, C₁-C₃ chlorinated hydrocarbons, C₃-C₆ allyl alkanoates, C₂-C₆ allyl cyanides, C₂-C₆ diallyl sulfoxides, and mixtures thereof. The carbon number ranges refer to the total number of carbon atoms in the solvent molecule. For example, a C₄-C₁₆ diallyl ether has 4 to 16 total carbon atoms, and the two alkyl groups may be the same or different. As another example, the 2 to 6 carbons in the “C₂-C₆ alkyl cyanides” include the carbon atom in the cyanide group. Specific ketone solvents include, for example, acetone, methyl ethyl ketone, methyl isobutyl ketone, and mixtures thereof. Specific N,N-dialkylamide solvents include, for example, dimethylformamide, dimethylacetamide, N-methyl-2-pyrrolidone (Chemical Abstracts Service Registry No. 872-50-4), and the like, and mixtures thereof. Specific dialkyl ether solvents include, for example, tetrahydrofuran, ethylene glycol monomethylether, dioxane, and the like, and mixtures thereof. The diallyl ether may, optionally, further include one or more ether oxygen atoms within the alkyl groups and one or more hydroxy group substituents on the allyl groups. The aromatic hydrocarbon solvent may or may not comprise an ethylenically unsaturated solvent. Specific aromatic hydrocarbon solvents include, for example, benzene, toluene, xylenes, styrene, divinylbenzenes, and the like, and mixtures thereof. The aromatic hydrocarbon solvent is preferably unhalogenated. That is, it does not include any fluorine, chlorine, bromine, or iodine atoms. Specific C₃-C₆ alkyl alkanoates include, for example, methyl acetate, ethyl acetate, methyl propionate, ethyl propionate, and the like, and mixtures thereof. Specific C₂-C₆ alkyl cyanides include, for example, acetonitrile, propionitrile, butyronitrile, and mixtures thereof. Specific C₂-C₆ dialkyl sulfoxides include, for example, dimethyl sulfoxide, methyl ethyl sulfoxide, diethyl sulfoxide, and the like, and mixtures thereof. In some embodiments, the solvent is acetone. In some embodiments, the solvent is methyl ethyl ketone. In some embodiments, the solvent is N-methyl-2-pyrrolidone. In some embodiments, the solvent is ethylene glycol monomethyl ether. In some embodiments, the solvent is toluene.

When the solvent is an aromatic hydrocarbon solvent containing ethylenic unsaturation, such as styrene or divinyl benzene, the compositions may, optionally, include a polymerization inhibitor. Suitable polymerization inhibitors are known in the art and include, for example, diazoaminobenzene, phenylacetylene, sym-trinitrobenzene, p-benzoquinone, acetaldehyde, aniline condensates, N,N′-dibutyl-o-phenylenediamine, N-butyl-p-aminophenol, 2,4,6-triphenylphenoxyl, pyrogallol, catechol, hydroquinone, monoalkylhydroquinones, p-methoxyphenol, t-butylhydroquinone, C₁-C₆-alkyl-substituted catechols, dialkylhydroquinone, 2,4,6-dichloronitrophenol, halogen-ortho-nitrophenols, alkoxyhydroquinones, mono- and di- and polysulfides of phenols and catechols, thiols, oximes and hydrazones of quinone, phenothiazine, dialkylhydroxylamines, and the like, and mixtures thereof. In some embodiments, the curing inhibitor comprises benzoquinone, hydroquinone, 4-t-butylcatechol, or a mixture thereof.

The composition components may be used in widely ranging amounts. In some embodiments, the composition comprises about 1 to about 70 weight percent of the poly(arylene ether) and about 30 to about 99 weight percent of the solvent. Within the above range, the composition may comprise the poly(arylene ether) in an amount of at least about 10 weight percent, or at least about 20 weight percent, or at least about 30 weight percent. Also within the above range, the composition may comprise the poly(arylene ether) in an amount of up to about 60 weight percent, or up to about 50 weight percent, or up to about 40 weight percent. Within the above range, the composition may comprise the solvent in an amount of at least about 40 weight percent, or at least about 50 weight percent, or at least about 60 weight percent. Also within the above range, the composition may comprise the solvent in an amount of up to about 90 weight percent, or up to about 80 weight percent, or up to about 70 weight percent.

The composition comprising the poly(arylene ether) and the solvent is useful for incorporating the poly(arylene ether) into a thermoset composition. Thus, in addition to the poly(arylene ether) and the solvent, the composition may, optionally, include a thermoset resin. For example, when the poly(arylene ether) is the product of oxidative polymerization of monomers free of ethylenic unsaturation, the composition may, optionally, further comprise a cyanate ester resin (such as the reaction product of a cyanogen halide and a bisphenol) or an epoxy resin (such as bisphenol A diglycidyl ether epoxy resin). As another example, when the poly(arylene ether) is the product of oxidative polymerization of monomers comprising a monohydric phenol comprising ethylenic unsaturation, the composition may, optionally, further comprise a thermoset resin comprising polymerizable carbon-carbon double bonds such as an unsaturated polyester resin or triallyl isocyanurate or a di-, tri-, tetra-, or pentafunctional (meth)acryloyl monomer. When the composition comprises a thermoset resin, it may, optionally, further comprise a filler and/or one or more additives for thermoset compositions, including curing promoters, curing inhibitors, dyes, pigments, colorants, antioxidants, heat stabilizers, light stabilizers, plasticizers, lubricants, flow modifiers, drip retardants, flame retardants, antiblocking agents, antistatic agents, flow-promoting agents, processing aids, substrate adhesion agents, mold release agents, toughening agents, low-profile additives, stress-relief additives, and combinations thereof. When used, the additional components are generally selected to have a substantially lower volatility than the solvent.

In some embodiments, the composition has a gel temperature less than or equal to 25° C. Gel temperature may be determined by a tilt test in which a gelled composition is gradually warmed in a test tube and the melting point is observed when the gel begins to flow under its own weight when the upright test tube is tilted. See, A. Hiltner in J. Brandup and E. H. Immergut, Eds., “Polymer Handbook”, Wiley-Interscience, New York: 1989, page VII/591.

One embodiment is a composition consisting of: a poly(arylene ether) that is the product of oxidative polymerization of monomers comprising a first monohydric phenol having identical substituents in the 2- and 6-positions, and a second monohydric phenol having different substituents in the 2- and 6-positions; wherein the monomers are free of ethylenic unsaturation; and a solvent selected from C₃-C₈ ketones, C₄-C₈ N,N-dialkylamides, C₄-C₁₆ dialkyl ethers, C₆-C₁₂ aromatic hydrocarbons, C₁-C₃ chlorinated hydrocarbons, C₂-C₆ alkyl cyanides, and mixtures thereof; wherein the poly(arylene ether) has a solubility in the composition of about 10 to about 700 grams per kilogram of composition at 25° C.

One embodiment is a composition comprising: a poly(arylene ether) that is the product of oxidative polymerization of monomers comprising about 30 to about 90 weight percent of a first monohydric phenol comprising 2,6-dimethylphenol, and about 10 to about 70 weight percent of a second monohydric phenol selected from 2-methylphenol, 2-methyl-6-phenylphenol, and mixtures thereof; wherein the weight percents of the first monohydric phenol and the second monohydric phenol are based on the total weight of monomers; wherein the monomers are free of ethylenic unsaturation; and wherein the poly(arylene ether) has an intrinsic viscosity of about 0.05 to about 0.6 deciliter per gram, measured at 25° C. in chloroform; and a solvent selected from acetone, methyl ethyl ketone, N-methyl-2-pyrrolidone, toluene, and mixtures thereof; wherein the poly(arylene ether) has a solubility in the composition of about 100 to about 700 grams per kilogram of composition at 25° C.; and wherein the poly(arylene ether) is soluble in the composition at 25° C. In some embodiments, the monomers further comprise a dihydric phenol selected from 2,2-bis(4-hydroxyphenyl)propane, 2,2-bis(4-hydroxy-2,6-dimethylphenyl)propane, 4,4-bis(3,5-dimethyl-4-hydroxyphenyl)pentanoic acid, 4,4-bis(4-hydroxyphenyl)pentanoic acid, 2,2′6,6′-tetramethyl-3,3′5,5′-tetrabromo-4,4′-biphenol, 2,2′5,5′-tetramethyl-4,4′-biphenol, and mixtures thereof.

One embodiment is a composition, consisting of: a poly(arylene ether) that is the product of oxidative polymerization of monomers comprising about 30 to about 90 weight percent of a first monohydric phenol comprising 2,6-dimethylphenol, about 10 to about 70 weight percent of a second monohydric phenol selected from 2-methylphenol, 2-methyl-6-phenylphenol, and mixtures thereof, and optionally, a dihydric phenol selected from 2,2-bis(4-hydroxyphenyl)propane, 2,2-bis(4-hydroxy-2,6-dimethylphenyl)propane, 4,4-bis(3,5-dimethyl-4-hydroxyphenyl)pentanoic acid, 4,4-bis(4-hydroxyphenyl)pentanoic acid, 2,2′6,6′-tetramethyl-3,3′5,5′-tetrabromo-4,4′-biphenol, 2,2′5,5′-tetramethyl-4,4′-biphenol, and mixtures thereof; wherein the weight percents of the first monohydric phenol and the second monohydric phenol are based on the total weight of monomers; wherein the monomers are free of ethylenic unsaturation; and wherein the poly(arylene ether) has an intrinsic viscosity of about 0.05 to about 0.6 deciliter per gram, measured at 25° C. in chloroform; and a solvent selected from acetone, methyl ethyl ketone, N-methyl-2-pyrrolidone, toluene, and mixtures thereof; wherein the poly(arylene ether) has a solubility in the composition of about 100 to about 700 grams per kilogram of composition at 25° C.; and wherein the poly(arylene ether) is soluble in the composition at 25° C.

One embodiment is a composition, comprising: about 20 to about 50 weight percent of a poly(arylene ether) that is the product of oxidative polymerization of monomers comprising about 30 to about 90 weight percent of a first monohydric phenol comprising 2,6-dimethylphenol, and about 10 to about 70 weight percent of a second monohydric phenol selected from 2-methylphenol, 2-methyl-6-phenylphenol, and mixtures thereof; wherein the monomers are free of ethylenic unsaturation; wherein the poly(arylene ether) has an intrinsic viscosity of about 0.1 to about 0.6 deciliter per gram, measured at 25° C. in chloroform; and wherein the weight percents of the first monohydric phenol and the second monohydric phenol are based on the total weight of monomers; about 20 to about 80 weight percent of a solvent selected from acetone, methyl ethyl ketone, N-methyl-2-pyrrolidone, toluene, and mixtures thereof; wherein the weight percents of the poly(arylene ether) and the solvent are based on the total weight of the composition; wherein the poly(arylene ether) has a solubility in the composition of about 100 to about 700 grams per kilogram of composition at 25° C.; and wherein the poly(arylene ether) is soluble in the composition at 25° C. In some embodiments, the monomers further comprise about 2 to about 20 weight percent of a dihydric phenol selected from 2,2-bis(4-hydroxyphenyl)propane, 2,2-bis(4-hydroxy-2,6-dimethylphenyl)propane, 4,4-bis(3,5-dimethyl-4-hydroxyphenyl)pentanoic acid, 4,4-bis(4-hydroxyphenyl)pentanoic acid 2,2′6,6′-tetramethyl-3,3′5,5′-tetrabromo-4,4′-biphenol, 2,2′5,5′-tetramethyl-4,4′-biphenol, and mixtures thereof.

One embodiment is a method of preparing a poly(arylene ether) composition, comprising: adjusting the temperature of a solvent to a temperature in a range from about 30° C. to the atmospheric boiling point of the solvent; wherein the solvent is selected from C₃-C₈ ketones, C₄-C₈ N,N-dialkylamides, C₄-C₁₆ dialkyl ethers, C₆-C₁₂ aromatic hydrocarbons, and mixtures thereof; combining the temperature-adjusted solvent with a poly(arylene ether) that is the product of oxidative polymerization of monomers comprising a first monohydric phenol having identical substituents in the 2- and 6-positions, and a second monohydric phenol having different substituents in the 2- and 6-positions; wherein the monomers are free of ethylenic unsaturation; and agitating the combined solvent and poly(arylene ether) to form the poly(arylene ether) composition; wherein the poly(arylene ether) has a solubility in the composition of at least 10 grams per kilogram of composition at 25° C. In the step of combining the temperature-adjusted solvent with a poly(arylene ether), it is sometimes desirable to gradually add the poly(arylene ether) to the solvent.

One embodiment is a composition, consisting of: a poly(arylene ether) that is the product of oxidative polymerization of monomers comprising a first monohydric phenol having identical substituents in the 2- and 6-positions, and a second monohydric phenol comprising ethylenic unsaturation and having different substituents in the 2- and 6-positions; and a solvent selected from C₃-C₈ ketones, C₄-C₈ N,N-dialkylamides, C₄-C₁₆ dialkyl ethers, C₆-C₁₂ aromatic hydrocarbons, C₁-C₃ chlorinated hydrocarbons, C₂-C₆ alkyl cyanides, and mixtures thereof; wherein the poly(arylene ether) has a solubility in the composition of about 10 to about 700 grams per kilogram of composition at 25° C.

One embodiment is a composition, comprising: a poly(arylene ether) that is the product of oxidative polymerization of monomers comprising about 30 to about 90 weight percent of a first monohydric phenol comprising 2,6-dimethylphenol, and about 10 to about 70 weight percent of a second monohydric phenol selected from 2-allylphenol, 2-methyl-6-allylphenol, and mixtures thereof; wherein the weight percents of the first monohydric phenol and the second monohydric phenol are based on the total weight of monomers; and wherein the poly(arylene ether) has an intrinsic viscosity of about 0.05 to about 0.6 deciliter per gram, measured at 25° C. in chloroform; and a solvent selected from methyl ethyl ketone, N-methyl-2-pyrrolidone, toluene, and mixtures thereof; wherein the poly(arylene ether) has a solubility in the composition of about 100 to about 700 grams per kilogram of composition at 25° C.; and wherein the poly(arylene ether) is soluble in the composition at 25° C. The monomers may, optionally, further comprise a dihydric phenol selected from 2,2-bis(4-hydroxyphenyl)propane, 2,2-bis(4-hydroxy-2,6-dimethylphenyl)propane, 4,4-bis(3,5-dimethyl-4-hydroxyphenyl)pentanoic acid, 4,4-bis(4-hydroxyphenyl)pentanoic acid 2,2′6,6′-tetramethyl-3,3′5,5′-tetrabromo-4,4′-biphenol, 2,2′5,5′-tetramethyl-4,4′-biphenol, and mixtures thereof.

One embodiment is a composition, consisting of: a poly(arylene ether) that is the product of oxidative polymerization of monomers comprising about 30 to about 90 weight percent of a first monohydric phenol comprising 2,6-dimethylphenol, about 10 to about 70 weight percent of a second monohydric phenol selected from 2-allylphenol, 2-methyl-6-allylphenol, and mixtures thereof, and, optionally, about 2 to about 20 weight percent of a dihydric phenol selected from 2,2-bis(4-hydroxyphenyl)propane, 2,2-bis(4-hydroxy-2,6-dimethylphenyl)propane, 4,4-bis(3,5-dimethyl-4-hydroxyphenyl)pentanoic acid, 4,4-bis(4-hydroxyphenyl)pentanoic acid, 2,2′6,6′-tetramethyl-3,3′5,5′-tetrabromo-4,4′-biphenol, 2,2′5,5′-tetramethyl-4,4′-biphenol, and mixtures thereof; wherein the weight percents of the first monohydric phenol and the second monohydric phenol are based on the total weight of monomers; and wherein the poly(arylene ether) has an intrinsic viscosity of about 0.05 to about 0.6 deciliter per gram, measured at 25° C. in chloroform; and a solvent selected from methyl ethyl ketone, N-methyl-2-pyrrolidone, toluene, and mixtures thereof; wherein the poly(arylene ether) has a solubility in the composition of about 100 to about 700 grams per kilogram of composition at 25° C.; and wherein the poly(arylene ether) is soluble in the composition at 25° C.

One embodiment is a composition, comprising: about 20 to about 50 weight percent of a poly(arylene ether) that is the product of oxidative polymerization of monomers comprising about 30 to about 96 weight percent of a first monohydric phenol comprising 2,6-dimethylphenol, about 2 to about 30 weight percent of a second monohydric phenol selected from 2-allylphenol, 2-methyl-6-allylphenol, and mixtures thereof, and about 2 to about 68 weight percent of a third monohydric phenol selected from 2-methylphenol, 2-methyl-6-phenylphenol, and mixtures thereof; wherein the weight percents of the first monohydric phenol, the second monohydric phenol, and third monohydric phenol are based on the total weight of monomers; and wherein the poly(arylene ether) has an intrinsic viscosity of about 0.1 to about 0.6 deciliters per gram, measured at 25° C. in chloroform; and about 20 to about 80 weight percent of a solvent selected from methyl ethyl ketone, N-methyl-2-pyrrolidone, toluene, and mixtures thereof; wherein the weight percents of the poly(arylene ether) and the solvent are based on the total weight of the composition; wherein the poly(arylene ether) has a solubility in the composition of about 100 to about 700 grams per kilogram of composition at 25° C.; and wherein the poly(arylene ether) is soluble in the composition at 25° C. The monomers may, optionally, further comprise about 2 to about 20 weight percent of a dihydric phenol selected from 2,2-bis(4-hydroxyphenyl)propane, 2,2-bis(4-hydroxy-2,6-dimethylphenyl)propane, 4,4-bis(3,5-dimethyl-4-hydroxyphenyl)pentanoic acid, 4,4-bis(4-hydroxyphenyl)pentanoic acid, 2,2′6,6′-tetramethyl-3,3′5,5′-tetrabromo-4,4′-biphenol, 2,2′5,5′-tetramethyl-4,4′-biphenol, and mixtures thereof.

One embodiment is a composition, consisting of: about 20 to about 50 weight percent of a poly(arylene ether) that is the product of oxidative polymerization of monomers comprising about 30 to about 96 weight percent of a first monohydric phenol comprising 2,6-dimethylphenol, about 2 to about 30 weight percent of a second monohydric phenol selected from 2-allylphenol, 2-methyl-6-allylphenol, and mixtures thereof, about 2 to about 68 weight percent of a third monohydric phenol selected from 2-methylphenol, 2-methyl-6-phenylphenol, and mixtures thereof, and optionally, about 2 to about 20 weight percent of a dihydric phenol selected from 2,2-bis(4-hydroxyphenyl)propane, 2,2-bis(4-hydroxy-2,6-dimethylphenyl)propane, 4,4-bis(3,5-dimethyl-4-hydroxyphenyl)pentanoic acid, 4,4-bis(4-hydroxyphenyl)pentanoic acid, 2,2′6,6′-tetramethyl-3,3′5,5′-tetrabromo-4,4′-biphenol, 2,2′5,5′-tetramethyl-4,4′-biphenol, and mixtures thereof; wherein the weight percents of the first monohydric phenol, the second monohydric phenol, and third monohydric phenol are based on the total weight of monomers; and wherein the poly(arylene ether) has an intrinsic viscosity of about 0.1 to about 0.6 deciliters per gram, measured at 25° C. in chloroform; and about 20 to about 80 weight percent of a solvent selected from methyl ethyl ketone, N-methyl-2-pyrrolidone, toluene, and mixtures thereof; wherein the weight percents of the poly(arylene ether) and the solvent are based on the total weight of the composition; wherein the poly(arylene ether) has a solubility in the composition of about 100 to about 700 grams per kilogram of composition at 25° C.; and wherein the poly(arylene ether) is soluble in the composition at 25° C.

One embodiment is a method of preparing a poly(arylene ether) composition, comprising: adjusting the temperature of a solvent to a temperature in a range from about 30° C. to the atmospheric boiling point of the solvent; wherein the solvent is selected from C₃-C₈ ketones, C₄-C₈ N,N-dialkylamides, C₄-C₁₆ dialkyl ethers, C₆-C₁₂ aromatic hydrocarbons, and mixtures thereof; combining the temperature-adjusted solvent with a poly(arylene ether) that is the product of oxidative polymerization of monomers a first monohydric phenol having identical substituents in the 2- and 6-positions, and a second monohydric phenol comprising ethylenic unsaturation and having different substituents in the 2- and 6-positions; and agitating the combined solvent and poly(arylene ether) to form the poly(arylene ether) composition; wherein the poly(arylene ether) has a solubility in the composition of about 100 to about 700 grams per kilogram of composition at 25° C. In the step of combining the temperature-adjusted solvent with a poly(arylene ether), it is sometimes desirable to gradually add the poly(arylene ether) to the solvent.

The invention is further illustrated by the following non-limiting examples.

### PREPARATIVE EXAMPLE 1

This example describes preparation of the monohydric phenol monomer 2-methyl-6-(1-phenylethyl)phenol (Chemical Abstracts Registry No. 17959-01-2). A 500-milliliter, three-neck, round bottom flask equipped with a mechanical stirrer, condenser, and nitrogen bypass connected to an oil bubbler was charged with 109.0 grams (0.0593 mole) of 2-methylphenol and heated to 60° C. The reaction mixture was treated with 1.60 grams (0.0593 mole) of aluminum flakes. After 0.5 hour, the aluminum flakes had dissolved, leaving a light brown, clear liquid. The mixture was heated to 180° C., at which point the evolution of gas was observed. The liquid was maintained at 180° C. for an additional 0.5 hour. The mixture was then cooled to 35° C., and styrene (105.0 grams, 1.008 moles) was added drop-wise through a pressure equalized addition funnel. The mixture was heated at 150° C. for 1 hour, then cooled to room temperature. Water (100 milliliters), toluene (200 milliliters), chloroform (600 milliliters), and 0.1 M hydrochloric acid (100 milliliters) were added, and the aqueous and organic layer was separated. The organic layer was washed with 3×100 milliliters of water and dried over magnesium sulfate. The solvent was removed under vacuum. The product was distilled under vacuum, exhibiting a boiling point of 155° C. at 0.1 kilopascal (1 torr). ¹H-NMR (D₆-DMSO) δ (ppm) 8.26 (s, 1H); 7.26 (m, 4H); 7.14 (m, 1H); 6.97 (d, 1H); 6.93 (d, 1H); 6.72 (t, 1H); 4.59 (q, 1H); 2.19 (s, 3H); 1.52 (d, 3H).

### PREPARATIVE EXAMPLE 2

This example describes a typical preparation of a homopolymer of 2,6-dimethylphenol. A five-neck, 1-liter round bottom flask equipped with an overhead stirrer, thermometer, and an oxygen diptube was charged with 0.125 grams (0.725 millimole) of N,N′-di-t-butylethylenediamine (DBEDA), 1.6 grams (15.8 millimole) of N,N-dimethylbutylamine (DMBA), 0.5 grams (3.87 millimole) of di-n-butylamine (DBA), 0.14 grams of methyltri-(C₈-C₁₀)-alkylammonium chloride obtained as Adogen 464, 100 grams of toluene, and 7.5 grams of a 50% toluene solution of 2,6-dimethylphenol (7.50 grams solution, 3.75 grams monomer, 31 millimoles monomer). A copper catalyst, 0.425 grams, (produced from a stock solution prepared by adding 14.3 grams of cuprous oxide to 187.07 grams of 48% hydrobromic acid), was added. With vigorous stirring oxygen was passed through the solution at 2 standard cubic feet per minute (SCFM) and a solution of 2,6-dimethylphenol (67.50 grams solution, 33.75 grams solution, 277 millimoles monomer). The reaction mixture was stirred for an additional 3 hours using a water bath to maintain a temperature of less than 35° C. The solution was then treated with 10 milliliters of glacial acetic acid to quench the catalyst. The polymer was isolated from the organic phase by methanol precipitation, and the resulting wet cake was dissolved in toluene and reprecipitated into methanol. The isolated solid dried overnight at 70° C. under vacuum.

Properties are summarized in Table 1. Weight average molecular weight (M_{w}), number average molecular weight (Mₙ), polydispersity index (M_{w}/Mₙ), and Z average molecular weight (M_{z}) were determined by gel permeation chromatography in chloroform using polystyrene standards. Molecular weights are expressed in atomic mass units (AMU). Glass transition temperature was determined by differential scanning calorimetry (DSC), using a Perlin Elmer Differential Scanning Calorimeter, a scan rate of 20° C. per minute, and a nitrogen atmosphere.

### PREPARATIVE EXAMPLE 3

Homopolymerization of 2-methyl-6-phenylphenol was conducted according to the procedure of Preparative Example 2, except that 2-methyl-6-phenylphenol was substituted (equimolar) for 2,6-dimethylphenol. Physical properties of the homopolymer so obtained are presented in Table 1.

### PREPARATIVE EXAMPLE 4

This example describes a typical preparation of a poly(arylene ether) copolymer (poly(2,6-dimethyl-1,4-phenylene-co-2-methyl-6-phenyl-1,4-phenylene ether) using an equimolar mixture of 2,6-dimethylphenol and 2-methyl-6-phenylphenol as comonomers. A five-neck, 1-liter round bottom flask equipped with an overhead stirrer, thermometer, and an oxygen diptube was charged with 0.125 grams (0.725 millimole) of DBEDA, 1.6 grams (15.8 millimoles) of DMBA, 0.5 grams (3.87 millimoles) of DBA, 0.14 grams of Adogen 464, 100 grams of toluene, and 5.6875 grams of a 50% toluene solution of 2-methyl-6-phenylphenol (2.84 grams, 15.6 millimoles; 10% of the total 2-methyl-6-phenylphenol) and 3.75 grams of a 50% toluene solution of 2,6-dimethylphenol (1.88 grams, 15.6 millimoles; 10% of the total 2,6-dimethylphenol). A copper catalyst, 0.425 grams, produced from a stock solution prepared by adding 14.3 grams of cuprous oxide to 187.07 grams of 48% hydrobromic acid, was added. An addition funnel was charged with 51.2 grams of a 50% toluene solution of 2-methyl-6-phenylphenol (25.59 grams, 140.6 millimoles, 90% of total 2-methyl-6-phenylphenol) and 33.8 grams of a 50% toluene solution of 2,6-dimethylphenol (16.88 grams, 140.6 millimoles, 90% of the total 2,6-dimethylphenol). With vigorous stirring, oxygen was passed through the solution at 2 SCFM while the toluene solution of 2-methyl-6-phenylphenol/2,6-dimethylphenol was added drop-wise to the reaction mixture over a period of 30 minutes. After addition was complete, the reaction mixture was stirred for an additional 2 hours. The solution was then treated with 10 milliliters of glacial acetic acid to quench the catalyst, and the polymer was isolated from solution by methanol precipitation. The isolated filter cake was redissolved into toluene and methanol reprecipitated. Physical properties of the copolymer so obtained are presented in Table 1.

### PREPARATIVE EXAMPLES 5-7

The procedure of Preparative Example 4 was used to prepare copolymers having the monomer compositions and properties specified for Preparative Examples 5-7 in Table 1. 2-Methyl-6-(1-phenylethyl)phenol (Chemical Abstracts Registry No. 17959-01-02) was synthesized as described in Preparative Example 1. 2-Methylphenol (ortho-cresol; Chemical Abstracts Registry No. 95-48-7), was obtained from Aldrich. Physical properties of the copolymers so obtained are presented in Table 1.

TABLE 1

| | P. Ex. 2 | P. Ex. 3 | P. Ex. 4 |
|---|---|---|---|
| Monomer Composition | | | |
| (wt %) | | | |
| 2,6-dimethylphenol | 100 | 0 | 50 |
| 2-methyl-6-phenylphenol | 0 | 100 | 50 |
| 2-methyl-6-benzylphenol | 0 | 0 | 0 |
| 2-methyl-6-(1-phenylethyl) | 0 | 0 | 0 |
| phenol | | | |
| 2-methylphenol | 0 | 0 | 0 |
| Properties | | | |
| M_{W} (AMU) | 50,213 | 79,978 | 74,761 |
| Mₙ (AMU) | 22,004 | 39,551 | 46,169 |
| M_{z} (AMU) | 90,239 | 156,373 | 107,395 |
| Polydispersity index | 2.28 | 2.02 | 1.62 |
| T_{g} (° C.) | 217 | 183 | 202 |
| | P. Ex. 5 | P. Ex. 6 | P. Ex. 7 |
| Monomer Composition | | | |
| (wt %) | | | |
| 2,6-dimethylphenol | 50 | 50 | 85 |
| 2-methyl-6-phenylphenol | 0 | 0 | 0 |
| 2-methyl-6-benzylphenol | 0 | 0 | 0 |
| 2-methyl-6-(1-phenylethyl) | 50 | 0 | 0 |
| phenol | | | |
| 2-methylphenol | 0 | 50 | 15 |
| Properties | | | |
| M_{w} (AMU) | 40,971 | 29,480 | 89,705 |
| Mₙ (AMU) | 6367 | 4,543 | 8,603 |
| M_{z} (AMU) | 109,610 | 322,307 | 454,855 |
| Polydispersity index | 1.63 | 6.49 | 10.43 |
| T_{g} (° C.) | 125.4 | 156 | — |

### EXAMPLES 1-4, COMPARATIVE EXAMPLES 1 AND 2

These examples describe testing of the solubility of the poly(arylene ether) homopolymers and copolymers whose preparation was described in Preparative Examples 2-7. Comparative Example 1 uses the homopolymer of 2,6-dimethylphenol prepared in Preparative Example 2. Comparative Examples 2 uses the homopolymer of 2-methyl-6-phenylphenol prepared in Preparative Example 3. Examples 1-4 use the copolymers prepared in Preparative Examples 4-7, respectively. Mixtures consisting of 20 weight percent poly(arylene ether) and 80 weight percent N-methyl-2-pyrrolidone (NMP), methyl ethyl ketone (MEK), or toluene were prepared at room temperature (23° C.). The polymers were dissolved in the designated solvent with stirring at room temperature and allowed to stand at room temperature for four hours. Mixtures were visually inspected and categorized as either inhomogeneous/insoluble (I/I; phase separated solid, or liquid), homogeneous/insoluble (H/I; gel-like), or homogenous and soluble (H/S; formed a transparent solution). The results, presented in Table 2, show that inventive copolymer compositions corresponding to Examples 1-4 all produced homogeneous solutions at room temperature in MEK, NMP, and toluene.

Gelation of the solution was determined using the tilt method described in A. Hiltner in J. Brandup and E. H. Immergut, Eds., “Polymer Handbook”, Wiley-Interscience, New York: 1989, page VII/591. Specifically, In the Table 2 summary of gelation properties, “Y” means gelling occurred at 25° C., “N” means no gelling occurred at 25° C., and “NM” means not measured.

TABLE 2

| | C. Ex. 1 | C. Ex. 2 | Ex. 1 |
|---|---|---|---|
| Monomer Composition (wt %) | | | |
| 2,6-dimethylphenol | 100 | 0 | 50 |
| 2-methyl-6-phenylphenol | 0 | 100 | 50 |
| 2-methyl-6-(1-phenylethyl)phenol | 0 | 0 | 0 |
| 2-methylphenol | 0 | 0 | 0 |
| Solubility Properties | | | |
| MEK solubility at 20% solids | I/I | I/I | H/S |
| NMP solubility at 20% solids | H/I | H/S | H/S |
| Toluene solubility at 20% solids | H/I | H/S | H/S |
| Gelation Properties | | | |
| MEK gelation after 24 h at 10% solids | — | — | N |
| MEK gelation after 24 h at 20% solids | — | — | N |
| MEK gelation after 24 h at 30% solids | — | — | N |
| NMP gelation after 24 h at 10% solids | Y | N | N |
| NMP gelation after 24 h at 20% solids | Y | N | N |
| NMP gelation after 24 h at 30% solids | Y | N | N |
| Toluene gelation after 24 h at 10% solids | Y | N | N |
| Toluene gelation after 24 h at 20% solids | Y | N | N |
| Toluene gelation after 24 h at 30% solids | Y | N | N |
| | Ex. 2 | Ex. 3 | Ex. 4 |
| Monomer Composition (wt %) | | | |
| 2,6-dimethylphenol | 50 | 50 | 85 |
| 2-methyl-6-phenylphenol | 0 | 0 | 0 |
| 2-methyl-6-(1-phenylethyl)phenol | 50 | 0 | 0 |
| 2-methylphenol | 0 | 50 | 15 |
| Solubility Properties | | | |
| MEK solubility at 20% solids | H/S | H/S | H/S |
| NMP solubility at 20% solids | H/S | H/S | H/S |
| Toluene solubility at 20% solids | H/S | H/S | H/S |
| Gelation Properties | | | |
| MEK gelation after 24 h at 10% solids | N | N | N |
| MEK gelation after 24 h at 20% solids | N | N | N |
| MEK gelation after 24 h at 30% solids | N | N | N |
| NMP gelation after 24 h at 10% solids | N | N | N |
| NMP gelation after 24 h at 20% solids | N | N | N |
| NMP gelation after 24 h at 30% solids | N | N | N |
| Toluene gelation after 24 h at 10% solids | N | N | N |
| Toluene gelation after 24 h at 20% solids | N | N | N |
| Toluene gelation after 24 h at 30% solids | N | N | N |

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

All ranges disclosed herein are inclusive of the endpoints, and the endpoints are independently combinable with each other.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

1. A composition, comprising:
a poly(arylene ether) that is the product of oxidative polymerization of monomers comprising a first monohydric phenol having identical substituents in the 2- and 6-positions, and a second monohydric phenol having different substituents in the 2- and 6-positions; wherein the monomers are free of ethylenic unsaturation; and
a solvent selected from the group consisting of C₃-C₈ ketones, C₄-C₈ N,N-dialkylamides, C₄-C₁₆ dialkyl ethers, C₆-C₁₂ aromatic hydrocarbons, C₁-C₃ chlorinated hydrocarbons, C₃-C₆ alkyl alkanoates, C₂-C₆ allyl cyanides, C₂-C₆ diallyl sulfoxides, and mixtures thereof;
wherein the poly(arylene ether) has a solubility in the composition of at least 10 grams per kilogram of composition at 25° C.

2. The composition of claim 1, wherein the poly(arylene ether) has a solubility in the composition of 10 to about 700 grams per kilogram of composition at 25° C.

3. The composition of claim 1, wherein the first monohydric phenol has the formula 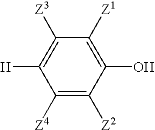
wherein Z¹ and Z² are the same and selected from the group consisting of halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; and Z³ and Z⁴ are the same or different and each independently selected from the group consisting of hydrogen, halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms.

4. The composition of claim 1, wherein the first monohydric phenol is selected from the group consisting of 2,6-dimethylphenol, 2,6-diphenylphenol, and mixtures thereof.

5. The composition of claim 1, wherein the first monohydric phenol is 2,6-dimethylphenol.

6. The composition of claim 1, wherein the second monohydric phenol has the formula 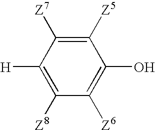
wherein Z⁵, Z⁶, Z⁷, and Z⁸ are each independently hydrogen, halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₁-C₁₂ halohydrocarbyloxy wherein at least two carbon atoms separate the halogen and oxygen atoms, with the proviso that Z⁵ and Z⁶ are different.

7. The composition of claim 1, wherein the second monohydric phenol is selected from the group consisting of 2-methylphenol, 2-ethylphenol, 2-(1-methylethyl)phenol, 2(1-methylpropyl)phenol, 2(1-methylbutyl)phenol, 2(1-methylpentyl)phenol, 2-(1-methylheptyl)phenol 2-(1-methylundecyl)phenol, 2-propylphenol, 2-cyclohexylphenol, 2-cyclopentylphenol, 2-cyclopropylphenol, 2-methyl-6-phenylphenol, 2-methyl-6-benzylphenol, 2-(1-phenylethyl)phenol, 2-methyl-6-(1-phenylethyl)phenol, 2-ethyl-6-methylphenol, 2-methyl-6-(1-methylethyl)phenol, 2-methyl-6-(1-methylpropyl)phenol, 2-methyl-6-(1-methylbutyl)phenol, 2-methyl-6-(1-methylpentyl)phenol, 2-methyl-6-(1-methylheptyl)phenol, 2-methyl-6-(1-methylundecyl)phenol, 2-methyl-6-propylphenol, 2-cyclohexyl-6-methylphenol, 2-cyclopentyl-6-methylphenol, 2-cyclopropyl-6-methylphenol, 2-methyl-6-methoxyphenol, 2-methyl-5-isopropylphenol, 2-isopropyl-5-methylphenol, 2,5-dimethylphenol, 3-pentadecylphenol, and mixtures thereof.

8. The composition of claim 1, wherein the second monohydric phenol is selected from the group consisting of 2-methylphenol, 2-phenylphenol, 2-methyl-6-phenylphenol, and mixtures thereof.

9. The composition of claim 1, wherein the monomers further comprise a dihydric phenol having the formula 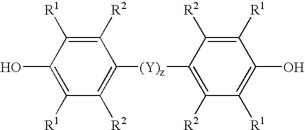
wherein each occurrence of R¹ and R² is independently selected from the group consisting of hydrogen, halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₁-C₁₂ halohydrocarbyloxy wherein at least two carbon atoms separate the halogen and oxygen atoms; z is 0 or 1; and Y has a structure selected from the group consisting of 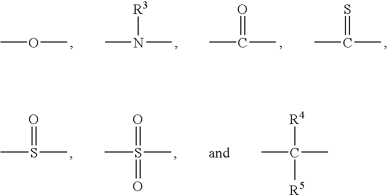
wherein each occurrence of R³ is independently selected from the group consisting of hydrogen and C₁-C₁₂ hydrocarbyl, and each occurrence of R⁴ and R⁵ is independently selected from the group consisting of hydrogen, C₁-C₁₂ hydrocarbyl, and C₁-C₆ hydrocarbylene wherein R⁴ and R⁵ collectively form a C₄-C₁₂ alkylene group.

10. The composition of claim 9, wherein the dihydric phenol is selected from the group consisting of 3,3′,5,5′-tetramethyl-4,4′-biphenol, 2,2-bis(3-methyl-4-hydroxyphenyl)propane, 2,2-bis(3,5-dimethyl-4-hydroxyphenyl)propane, 1,1-bis(4-hydroxyphenyl)methane, 1,1-bis(4-hydroxyphenyl)ethane, 2,2-bis(4-hydroxyphenyl)propane 2,2-bis(4-hydroxyphenyl)butane, 2,2-bis(4-hydroxyphenyl)octane, 1,1-bis(4-hydroxyphenyl)propane, 1,1-bis(4-hydroxyphenyl)-n-butane, bis(4-hydroxyphenyl)phenylmethane, 2,2-bis(4-hydroxy-3-methylphenyl)propane, 1,1-bis(4-hydroxy-3-methylphenyl)cyclohexane, 1,1-bis(4-hydroxy-3,5-dimethylphenyl)cyclopentane, 1,1-bis(4-hydroxy-3,5-dimethylphenyl)cyclohexane, 1,1-bis(4-hydroxy-3-methylphenyl)cycloheptane, 1,1-bis(4-hydroxy-3,5-dimethylphenyl)cycloheptane, 1,1-bis(4-hydroxy-3-methylphenyl)cyclooctane, 1,1-bis(4-hydroxy-3,5-dimethylphenyl)cyclooctane, 1,1-bis(4-hydroxy-3-methylphenyl)cyclononane, 11,1-bis(4-hydroxy-3,5-dimethylphenyl)cyclononane, 1,1-bis(4-hydroxy-3-methylphenyl)cyclodecane, 1,1-bis(4-hydroxy-3,5-dimethylphenyl)cyclodecane, 1,1-bis(4-hydroxy-3-methylphenyl)cycloundecane, 1,1-bis(4-hydroxy-3,5-dimethylphenyl)cycloundecane, 1,1-bis(4-hydroxy-3-methylphenyl)cyclododecane, 1,1-bis(4-hydroxy-3,5-dimethylphenyl)cyclododecane, 1,1-bis(4-hydroxy-3-t-butylphenyl)propane, 2,2-bis(4-hydroxy-2,6-dimethylphenyl)propane, 2,2-bis(4-hydroxy-3-bromophenyl)propane, 1,1-bis(4-hydroxyphenyl)cyclopentane, 1,1-bis(4-hydroxyphenyl)cyclohexane, and mixtures thereof.

11. The composition of claim 1, wherein the monomers comprise about 1 to about 90 weight percent of the first monohydric phenol and about 10 to about 99 weight percent of the second monohydric phenol, based on the total weight of the monomers.

12. The composition of claim 1, wherein the poly(arylene ether) has an intrinsic viscosity of about 0.05 to about 1.5 deciliters per gram, measured at 25° C. in chloroform.

13. The composition of claim 1, wherein the poly(arylene ether) has an intrinsic viscosity of about 0.2 to about 0.6 deciliter per gram, measured at 25° C. in chloroform.

14. The composition of claim 1, wherein the solvent comprises a C₃-C₈ ketone.

15. The composition of claim 1, wherein the solvent is selected from the group consisting of acetone, methyl ethyl ketone, methyl isobutyl ketone, and mixtures thereof.

16. The composition of claim 1, wherein the solvent comprises acetone.

17. The composition of claim 1, wherein the solvent comprises a C₄-C₈ N,N-dialkylamide.

18. The composition of claim 1, wherein the solvent is selected from the group consisting of dimethylformamide, dimethylacetamide, N-methyl-2-pyrrolidone, and mixtures thereof.

19. The composition of claim 1, wherein the solvent comprises N-methyl-2-pyrrolidone.

20. The composition of claim 1, wherein the solvent comprises a C₄-C₁₆ dialkyl ether.

21. The composition of claim 1, wherein the solvent is selected from the group consisting of ethylene glycol monomethyl ether, tetrahydrofuran, dioxane, and mixtures thereof.

22. The composition of claim 1, wherein the solvent is ethylene glycol monomethyl ether.

23. The composition of claim 1, wherein the solvent comprises a C₆-C₁₂ aromatic hydrocarbon.

24. The composition of claim 1, wherein the solvent is selected from the group consisting of benzene, toluene, xylenes, styrene, divinylbenzenes, and mixtures thereof.

25. The composition of claim 1, wherein the solvent is toluene.

26. The composition of claim 1, wherein the solvent comprises a C₁-C₃ chlorinated hydrocarbon.

27. The composition of claim 1, wherein the solvent is selected from the group consisting of trichloroethylene, trichloroethane, methylene chloride, and mixtures thereof.

28. The composition of claim 1, wherein the solvent comprises a C₃-C₆ alkyl alkanoate.

29. The composition of claim 1, wherein the solvent is selected from the group consisting of methyl acetate, ethyl acetate, methyl propionate, ethyl propionate, and mixtures thereof.

30. The composition of claim 1, wherein the solvent comprises a C₂-C₆ alkyl cyanide.

31. The composition of claim 1, wherein the solvent is selected from the group consisting of acetonitrile, propionitrile, butyronitrile, and mixtures thereof.

32. The composition of claim 1, wherein the solvent comprises a C₂-C₆ diallyl sulfoxide.

33. The composition of claim 1, wherein the solvent comprises dimethyl sulfoxide.

34. The composition of claim 1, comprising about 1 to about 70 weight percent of the poly(arylene ether) and about 30 to about 99 weight percent of the solvent, based on the total weight of the composition.

35. The composition of claim 1, comprising about 10 to about 50 weight percent of the poly(arylene ether) and about 50 to about 90 weight percent of the solvent, based on the total weight of the composition.

36. The composition of claim 1, wherein the poly(arylene ether) has a solubility in the composition of at least 100 grams per kilogram of composition at 25° C.

37. The composition of claim 1, wherein the poly(arylene ether) has a solubility in the composition of at least 200 grams per kilogram of composition at 25° C.

38. The composition of claim 1, wherein the poly(arylene ether) is soluble in the composition at 25° C.

39. The composition of claim 1, having a gel temperature less than or equal to 25° C.

40. The composition of claim 1, further comprising a thermoset resin.

41. The composition of claim 40, further comprising a filler.

42. The composition of claim 40, further comprising an additive selected from the group consisting of curing promoters, curing inhibitors, dyes, pigments, colorants, antioxidants, heat stabilizers, light stabilizers, plasticizers, lubricants, flow modifiers, drip retardants, flame retardants, antiblocking agents, antistatic agents, flow-promoting agents, processing aids, substrate adhesion agents, mold release agents, toughening agents, low-profile additives, stress-relief additives, and combinations thereof.

43. A composition, comprising:
a poly(arylene ether) that is the product of oxidative polymerization of monomers comprising a first monohydric phenol having identical substituents in the 2- and 6-positions, and a second monohydric phenol having different substituents in the 2- and 6-positions; wherein the monomers are free of ethylenic unsaturation; and
a solvent comprising a C₃-C₈ ketone;
wherein the poly(arylene ether) has a solubility in acetone of at least 10 grams per kilogram at 25° C., based on the total weight of poly(arylene ether) and acetone.

44. A composition, comprising:
a poly(arylene ether) that is the product of oxidative polymerization of monomers comprising a first monohydric phenol having identical substituents in the 2- and 6-positions, and a second monohydric phenol having different substituents in the 2- and 6-positions; wherein the monomers are free of ethylenic unsaturation; and
a solvent comprising a C₄-C₈ N,N-dialkylamide;
wherein the poly(arylene ether) has a solubility in N,N-dimethylformamide of at least 10 grams per kilogram at 25° C., based on the total weight of poly(arylene ether) and N,N-dimethylformamide.

45. A composition, comprising:
a poly(arylene ether) that is the product of oxidative polymerization of monomers comprising a first monohydric phenol having identical substituents in the 2- and 6-positions, and a second monohydric phenol having different substituents in the 2- and 6-positions; wherein the monomers are free of ethylenic unsaturation; and
a solvent comprising a C₄-C₁₆ dialkyl ether;
wherein the poly(arylene ether) has a solubility in ethylene glycol monomethyl ether of at least 10 grams per kilogram at 25° C., based on the total weight of poly(arylene ether) and ethylene glycol monomethyl ether.

46. A composition, comprising:
a poly(arylene ether) that is the product of oxidative polymerization of monomers comprising a first monohydric phenol having identical substituents in the 2- and 6-positions, and a second monohydric phenol having different substituents in the 2- and 6-positions; wherein the monomers are free of ethylenic unsaturation; and
a solvent comprising a C₆-C₁₂ aromatic hydrocarbon;
wherein the poly(arylene ether) has a solubility in toluene of at least 10 grams per kilogram at 25° C., based on the total weight of poly(arylene ether) and toluene.

47. A composition, comprising:
a poly(arylene ether) that is the product of oxidative polymerization of monomers comprising a first monohydric phenol having identical substituents in the 2- and 6-positions, and a second monohydric phenol having different substituents in the 2- and 6-positions; wherein the monomers are free of ethylenic unsaturation; and
a solvent comprising a C₁-C₃ chlorinated hydrocarbon;
wherein the poly(arylene ether) has a solubility in trichloroethylene of at least 10 grams per kilogram at 25° C., based on the total weight of poly(arylene ether) and trichloroethylene.

48. A composition, comprising:
a poly(arylene ether) that is the product of oxidative polymerization of monomers comprising a first monohydric phenol having identical substituents in the 2- and 6-positions, and a second monohydric phenol having different substituents in the 2- and 6-positions; wherein the monomers are free of ethylenic unsaturation; and
a solvent comprising a C₃-C₆ alkyl alkanoate;
wherein the poly(arylene ether) has a solubility in ethyl acetate of at least 10 grams per kilogram at 25° C., based on the total weight of poly(arylene ether) and ethyl acetate.

49. A composition, comprising:
a poly(arylene ether) that is the product of oxidative polymerization of monomers comprising a first monohydric phenol having identical substituents in the 2- and 6-positions, and a second monohydric phenol having different substituents in the 2- and 6-positions; wherein the monomers are free of ethylenic unsaturation; and
a solvent comprising a C₂-C₆ alkyl cyanide;
wherein the poly(arylene ether) has a solubility in acetonitrile of at least 10 grams per kilogram at 25° C., based on the total weight of poly(arylene ether) and acetonitrile.

50. A composition, consisting of:
a poly(arylene ether) that is the product of oxidative polymerization of monomers comprising a first monohydric phenol having identical substituents in the 2- and 6-positions, and a second monohydric phenol having different substituents in the 2- and 6-positions; wherein the monomers are free of ethylenic unsaturation; and
a solvent selected from the group consisting of C₃-C₈ ketones, C₄-C₈ N,N-dialkylamides, C₄-C₁₆ diallyl ethers, C₆-C₁₂ aromatic hydrocarbons, and mixtures thereof;
wherein the poly(arylene ether) has a solubility in the composition of about 10 to about 700 grams per kilogram of composition at 25° C.

51. A composition, comprising:
a poly(arylene ether) that is the product of oxidative polymerization of monomers comprising
about 30 to about 90 weight percent of a first monohydric phenol comprising 2,6-dimethylphenol, and
about 10 to about 70 weight percent of a second monohydric phenol selected from the group consisting of 2-methylphenol, 2-methyl-6-phenylphenol, and mixtures thereof;
wherein the weight percents of the first monohydric phenol and the second monohydric phenol are based on the total weight of monomers; wherein the monomers are free of ethylenic unsaturation; and wherein the poly(arylene ether) has an intrinsic viscosity of about 0.05 to about 0.6 deciliter per gram, measured at 25° C. in chloroform; and
a solvent selected from the group consisting of acetone, methyl ethyl ketone, N-methyl-2-pyrrolidone, toluene, and mixtures thereof;
wherein the poly(arylene ether) has a solubility in the composition of about 100 to about 700 grams per kilogram of composition at 25° C.; and
wherein the poly(arylene ether) is soluble in the composition at 25° C.

52. The composition of claim 51, wherein the monomers further comprise a dihydric phenol selected from the group consisting of 2,2-bis(4-hydroxyphenyl)propane, 2,2-bis(4-hydroxy-2,6-dimethylphenyl)propane, 4,4-bis(3,5-dimethyl-4-hydroxyphenyl)pentanoic acid, 4,4-bis(4-hydroxyphenyl)pentanoic acid, 2,2′6,6′-tetramethyl-3,3′5,5′-tetrabromo-4,4′-biphenol, 2,2′5,5′-tetramethyl-4,4′-biphenol, and mixtures thereof.

53. A composition, consisting of:
a poly(arylene ether) that is the product of oxidative polymerization of monomers comprising
about 30 to about 90 weight percent of a first monohydric phenol comprising 2,6-dimethylphenol,
about 10 to about 70 weight percent of a second monohydric phenol selected from the group consisting of 2-methylphenol, 2-methyl-6-phenylphenol, and mixtures thereof, and
optionally, a dihydric phenol selected from the group consisting of 2,2-bis(4-hydroxyphenyl)propane, 2,2-bis(4-hydroxy-2,6-dimethylphenyl)propane, 4,4-bis(3,5-dimethyl-4-hydroxyphenyl)pentanoic acid, 4,4-bis(4-hydroxyphenyl)pentanoic acid, 2,2′6,6′-tetramethyl-3,3′5,5′-tetrabromo-4,4′-biphenol, 2,2′5,5′-tetramethyl-4,4′-biphenol, and mixtures thereof;
wherein the weight percents of the first monohydric phenol and the second monohydric phenol are based on the total weight of monomers; wherein the monomers are free of ethylenic unsaturation; and wherein the poly(arylene ether) has an intrinsic viscosity of about 0.05 to about 0.6 deciliters per gram, measured at 25° C. in chloroform; and
a solvent selected from the group consisting of acetone, methyl ethyl ketone, N-methyl-2-pyrrolidone, toluene, and mixtures thereof;
wherein the poly(arylene ether) has a solubility in the composition of about 100 to about 700 grams per kilogram of composition at 25° C.; and
wherein the poly(arylene ether) is soluble in the composition at 25° C.

54. A composition, comprising:
about 20 to about 50 weight percent of a poly(arylene ether) that is the product of oxidative polymerization of monomers comprising
about 30 to about 90 weight percent of a first monohydric phenol comprising 2,6-dimethylphenol, and
about 10 to about 70 weight percent of a second monohydric phenol selected from the group consisting of 2-methylphenol, 2-methyl-6-phenylphenol, and mixtures thereof;
wherein the monomers are free of ethylenic unsaturation; wherein the poly(arylene ether) has an intrinsic viscosity of about 0.1 to about 0.6 deciliter per gram, measured at 25° C. in chloroform; and wherein the weight percents of the first monohydric phenol and the second monohydric phenol are based on the total weight of monomers;
about 20 to about 80 weight percent of a solvent selected from the group consisting of acetone, methyl ethyl ketone, N-methyl-2-pyrrolidone, toluene, and mixtures thereof;
wherein the weight percents of the poly(arylene ether) and the solvent are based on the total weight of the composition;
wherein the poly(arylene ether) has a solubility in the composition of about 100 to about 700 grams per kilogram of composition at 25° C.; and
wherein the poly(arylene ether) is soluble in the composition at 25° C.

55. The composition of claim 54, wherein the monomers further comprise about 2 to about 20 weight percent of a dihydric phenol selected from the group consisting of 2,2-bis(4-hydroxyphenyl)propane, 2,2-bis(4-hydroxy-2,6-dimethylphenyl)propane, 4,4-bis(3,5-dimethyl-4-hydroxyphenyl)pentanoic acid, 4,4-bis(4-hydroxyphenyl)pentanoic acid, 2,2′6,6′-tetramethyl-3,3′5,5′-tetrabromo-4,4′-biphenol, 2,2′5,5′-tetramethyl-4,4′-biphenol, and mixtures thereof.

56. A composition, consisting of:
about 20 to about 50 weight percent of a poly(arylene ether) that is the product of oxidative polymerization of monomers comprising
about 30 to about 90 weight percent of a first monohydric phenol comprising 2,6-dimethylphenol,
about 10 to about 70 weight percent of a second monohydric phenol selected from the group consisting of 2-methylphenol, 2-methyl-6-phenylphenol, and mixtures thereof, and
optionally, about 2 to about 20 weight percent of a dihydric phenol selected from the group consisting of 2,2-bis(4-hydroxyphenyl)propane, 2,2-bis(4-hydroxy-2,6-dimethylphenyl)propane, 4,4-bis(3,5-dimethyl-4-hydroxyphenyl)pentanoic acid, 4,4-bis(4-hydroxyphenyl)pentanoic acid, 2,2′6,6′-tetramethyl-3,3′5,5′-tetrabromo-4,4′-biphenol, 2,2′5,5′-tetramethyl-4,4′-biphenol, and mixtures thereof;
wherein the monomers are free of ethylenic unsaturation; wherein the poly(arylene ether) has an intrinsic viscosity of about 0.1 to about 0.6 deciliter per gram, measured at 25° C. in chloroform; and wherein the weight percents of the first monohydric phenol and the second monohydric phenol are based on the total weight of monomers;
about 20 to about 80 weight percent of a solvent selected from the group consisting of acetone, methyl ethyl ketone, N-methyl-2-pyrrolidone, toluene, and mixtures thereof;
wherein the weight percents of the poly(arylene ether) and the solvent are based on the total weight of the composition;
wherein the poly(arylene ether) has a solubility in the composition of about 100 to about 700 grams per kilogram of composition at 25° C.; and
wherein the poly(arylene ether) is soluble in the composition at 25° C.

57. A method of preparing a poly(arylene ether) composition, comprising:
adjusting the temperature of a solvent to a temperature in a range from about 30° C. to the atmospheric boiling point of the solvent; wherein the solvent is selected from the group consisting of C₃-C₈ ketones, C₄-C₈ N,N-dialkylamides, C₄-C₁₆ dialkyl ethers, C₆-C₁₂ aromatic hydrocarbons, and mixtures thereof;
combining the temperature-adjusted solvent with a poly(arylene ether) that is the product of oxidative polymerization of monomers comprising a first monohydric phenol having identical substituents in the 2- and 6-positions, and a second monohydric phenol having different substituents in the 2- and 6-positions; wherein the monomers are free of ethylenic unsaturation; and
agitating the combined solvent and poly(arylene ether) to form the poly(arylene ether) composition;
wherein the poly(arylene ether) has a solubility in the composition of at least 10 grams per kilogram of composition at 25° C.

58. The method of claim 57, wherein said combining the temperature-adjusted solvent with a poly(arylene ether) comprises adding the poly(arylene ether) to the solvent.
